(19) United States
(12) Patent Application Publication
(10) Pub. No.: US 2025/0118010 A1
(43) Pub. Date: Apr. 10, 2025

(54) HIERARCHICAL SCENE MODELING FOR SELF-DRIVING VEHICLES

(71) Applicant: NEC Laboratories America, Inc., Princeton, NJ (US)

(72) Inventors: Ziyu Jiang, San Jose, CA (US); Bingbing Zhuang, Santa Clara, CA (US); Manmohan Chandraker, Santa Clara, CA (US)

(21) Appl. No.: 18/903,411

(22) Filed: Oct. 1, 2024

Related U.S. Application Data
(60) Provisional application No. 63/542,387, filed on Oct. 4, 2023.
(60) Provisional application No. 63/542,383, filed on Oct. 4, 2023.
(60) Provisional application No. 63/599,154, filed on Nov. 15, 2023.
(60) Provisional application No. 63/542,403, filed on Oct. 4, 2023.

(51) Int. Cl. G06T 15/08; G06T 15/06; G06T 15/50

(52) U.S. Cl. CPC G06T 15/08; G06T 15/06; G06T 15/503; G06T 2210/12; G06T 2210/21

(57) ABSTRACT

A computer-implemented method for synthesizing an image includes capturing data from a scene and decomposing the captured scene into static objects; dynamic objects and sky. Bounding boxes are generated for the dynamic objects and motion is simulated for the dynamic objects as static movement of the bounding boxes. The dynamic objects and the static objects are merged according to density and color of sample points. The sky is blended into a merged version of the dynamic objects and the static objects, and an image is synthesized from volume rendered rays.

### RELATED APPLICATION INFORMATION

This application claims priority to U.S. Provisional Patent Application No. 63/542,383 filed on Oct. 4, 2023, incorporated herein by reference in its entirety. This application claims priority to U.S. Provisional Patent Application No. 63/542,387 filed on Oct. 4, 2023, incorporated herein by reference in its entirety. This application claims priority to U.S. Provisional Patent Application No. 63/542,403 filed on Oct. 4, 2023, incorporated herein by reference in its entirety. This application claims priority to U.S. Provisional Patent Application No. 63/599,154 filed on Nov. 15, 2023, incorporated herein by reference in its entirety.

This application is related to U.S. Patent Application Ser. No. TBD (Attorney docket number 23061), entitled “VIEW SYNTHESIS FOR SELF-DRIVING” filed currently herewith.

### BACKGROUND

### Technical Field

The present invention relates to artificial intelligence (AI) systems, and more particularly, to automatically trained systems and methods to identify objects for self-driving vehicles.

### Description of the Related Art

Robust simulation systems are an important tool in self-driving and advanced driving assistance systems (ADAS), as they offer a cost-effective and scalable way for training and verification of autonomy, especially in safety-critical scenarios. Traditional methods typically approach this problem by manual three-dimensional (3D) asset creation followed by procedural computer graphic rendering pipelines. These pipelines require large amounts of human effort, and the results are not scalable and cost-effective.

### SUMMARY

According to an aspect of the present invention, a computer-implemented method for synthesizing an image includes capturing data from a scene and fusing grid-based representations of the scene from different encodings to inherit beneficial properties of the different encodings. The encodings include Lidar encoding and a high definition map encoding. Rays are rendered from fused grid-based representations. A density and color are determined for points in the rays. A volume rendering is employed for the rays with the density and color. An image is synthesized from the volume rendered rays with the density and the color.

According to another aspect of the present invention, a computer-implemented method for synthesizing an image includes capturing data from a scene; fusing representations from a plurality of different encodings to inherit beneficial properties of the different encodings, the plurality of encodings including positioning encoding wherein the positioning encoding provides a distance aware property; rendering rays from fused grid-based representations; determining a density for points in the rays; determining a color for the points in the rays; volume rendering the rays with the density and color; and synthesizing an image from volume rendered rays with density and color rendered in accordance with distance aware property.

According to another aspect of the present invention, a computer-implemented method for synthesizing an image includes capturing data from a scene; tracking information for objects in the scene; point sampling inside object boxes for the moving objects; computing an intersection between a viewing ray and sampled points along the ray inside the object boxes; integrating position encoding over a corresponding space provided by the intersections where a size of the corresponding space depends on a viewing distance to provide a distance aware property; generating a three dimensional (3D) hash map feature grid; employing a geometry multilayer perceptron (MLP) to concatenate the position encoding and the 3D hash map feature grid to regress a density; regressing color using a color MLP along a rendering ray; and volume rendering the density and the color along the rendering ray to render a synthesized image.

According to another aspect of the present invention, a computer-implemented method for synthesizing an image includes capturing data from a scene; decomposing the captured scene into static objects; dynamic objects and sky; generating bounding boxes for the dynamic objects; simulating motion of the dynamic objects as static with movement of the bounding boxes; merging the dynamic objects and the static objects according to density and color of sample points; blending the sky into a merged version of the dynamic objects and the static objects; and synthesizing an image from volume rendered rays.

These and other features and advantages will become apparent from the following detailed description of illustrative embodiments thereof, which is to be read in connection with the accompanying drawings.

### BRIEF DESCRIPTION OF DRAWINGS

The disclosure will provide details in the following description of preferred embodiments with reference to the following figures wherein:

FIG. 1 is a block/flow diagram illustrating a system/method for synthesizing images using a plurality of encodings, in accordance with an embodiment of the present invention;

FIG. 2 is a block/flow diagram illustrating a system/method for employing neural radiance field for synthesizing images using a plurality of encodings, in accordance with an embodiment of the present invention;

FIG. 3 is a block/flow diagram illustrating a system/method for synthesizing images with depth or position aware encodings, in accordance with an embodiment of the present invention;

FIG. 4 is a schematic diagram implementing a depth or position aware element, in accordance with an embodiment of the present invention;

FIG. 5 is a block/flow diagram illustrating a system/method for synthesizing images using hierarchical decomposition of static, dynamic and sky objects, in accordance with an embodiment of the present invention;

FIG. 6 is a diagram showing a real image and a synthetic image, in accordance with an embodiment of the present invention;

FIG. 7 is a block/flow diagram illustrating a system for synthesizing images, in accordance with an embodiment of the present invention;

FIG. 8 is a flow diagram illustrating methods for synthesizing images using a plurality of encodings, in accordance with an embodiment of the present invention;

FIG. 9 is a flow diagram illustrating methods for synthesizing images with depth or position aware encodings, in accordance with an embodiment of the present invention;

FIG. 10 is a flow diagram illustrating methods for synthesizing images using hierarchical decomposition of static, dynamic and sky objects, in accordance with an embodiment of the present invention; and

FIG. 11 is a schematic diagram showing an autonomous vehicle system which employs systems/methods, in accordance with embodiments of the present invention.

### DETAILED DESCRIPTION OF PREFERRED EMBODIMENTS

In accordance with embodiments of the present invention, systems and methods are described that provide camera and image simulation with high resolution and rich semantics to employ neural radiance field (NeRF) to develop a fully automatic pipeline for image simulation. The present systems take as input real driving logs, build a 3D digital twin (e.g., 3D reconstruction with NeRF) for captured scenes, edit the digital twin to generate diverse virtual scenarios, and conduct novel view synthesis through differentiable rendering to simulate image data. The present systems are fully automatic.

NeRF works well given dense scene coverage and when the novel views are spatially close to the training views, however, performance degradation can be experiences under sparse view coverage and when the novel views are spatially far from the training views, e.g., extrapolation of viewpoints. Simulation in driving scenes falls into this challenging category due to colinear motion of vehicles. In addition, a full simulation system also needs view extrapolation capability, where an example use case can include changing the lane of an ego-vehicle and render new images accordingly.

Simulation of image data is needed for the training and verification of modern autonomous driving systems. As a part of traffic, the simulation of vehicles is a component for a complete simulation system. In accordance with embodiments of the present invention, 3D object assets are automatically created from real driving data without manual effort, leading to a low-cost and scalable system for wide deployment.

This is in contrast with a traditional asset creation pipeline in an existing autonomy system or game industry, where a large number of artists are hired to manually create computer aided design (CAD) models as 3D assets.

To achieve automatic asset creation with both high quality and high efficiency, the data distribution largely deviating from the favorable object-centric image collection needs to be addressed. Under real driving scenes in the wild, objects may appear to be at varying distances from the camera depending on the trajectory of both the ego vehicle and surrounding agents. This diversity in distribution degrades the rendering quality of NeRF with alias. In addition, vanilla multiple-layered perceptron (MLP) based NeRF is computationally expensive due to the dense matrix multiplication in MLP, and hence is not applicable for asset creation due to the large amount of traffic participants causing prohibitive computational cost.

Simulation for autonomous driving systems can significantly mitigate the need for training data and on-road testing, thus facilitating the progression of the autonomous driving technologies. Within the simulation framework, appearance simulation ensures realism for the rendered images. Conventional NeRF methodologies fail to handle the autonomous driving scene, especially in the context of sky and dynamic objects. The challenge in accurately encoding the sky arises from rays never intersecting with any opaque surface of the sky. Moreover, the texture of the sky is often perceived as simple due to its frequent presentation of vast, uninterrupted expanses of color, such as the serene and unblemished blue observed on a clear day. These factors cause the difficulty for NeRF in modelling the correct geometric information of sky and consequently degrade the performance. Another challenge that NeRF encounters is that NeRF is designed for encoding static objects rather than dynamic objects, leading to difficulty in accurately representing the dynamic cars in the scene.

In accordance with embodiments of the present invention, systems and methods, view extrapolation improvements are described especially under sparse view coverage such as in a driving scenario. While there are other limitations in the NeRF scene representation, the above degradation is mainly caused by NeRF not being able to reconstruct surface geometry of the scene, as color rendering is the only concern in NeRF training and the underlying geometry is only defined implicitly and indirectly. Another important reason lies in that NeRF lacks the notion of semantics and is not able to leverage any scene prior for regularization. Given that self-driving vehicles are often equipped with Light Detection and Ranging (LiDAR or Lidar) in addition to cameras, as well as the existence of high-definition (HD) maps collected for localization and navigation purposes, the present embodiments provide a new framework to leverage Lidar and HD maps for the purpose of improving simulation. Lidar directly captures the scene geometry and hence provides strong guidance for the geometry learning in NeRF. HD maps encode the semantic information, which holds the potential for NeRF to learn a scene prior and thereby facilitating rendering from extrapolated viewpoints.

Deep neural networks are applied to extract geometry features and semantic features from Lidar and HD maps, respectively. For Lidar, point clouds are voxelized into sparse voxels and a 3D sparse convolutional network is applied to extract a 3D grid of geometry features. For the HD map, 2D convolutional networks are applied to extract a 2D grid of semantic features represented in a bird's eye view. A NeRF representation in accordance with embodiments of the present invention is employed as a component which lies in a hash grid that efficiently maps each 3D point into a feature vector, which are then passed to multi-layer perceptrons (MLPs) for decoding density and color, and then volume rendering follows to synthesize images from novel views. Besides the original features from the hash grid, features from the Lidar feature gird are additionally retrieved as well as the HD map feature grid. These features are concatenated with the hash grid feature before being fed to the MLPs. In this way, NeRF training is supplied with rich geometry and semantic prior of the scene, leading to improved view extrapolation performance.

The present systems enable view extrapolation capability in image simulation under driving scenes. Lidar and HD maps are leveraged with Lidar as geometry supervision through a depth loss during NeRF training. The system framework takes Lidar as input to the NeRF network, which utilizes the Lidar sensor to paint the Lidar with color by projecting point clouds into image planes captured by the camera and retrieving color from the corresponding pixels. This associates the geometry with color and further facilitates the rendering task. Furthermore, the HD map is utilized in a NeRF framework to improve novel view synthesis in driving scenes and leverage the semantic prior in the HD map to enable high-quality rendering in extrapolated novel views.

Lidar is used as depth supervision for NeRF training. Due to the sparse nature of Lidar point clouds, multiple nearby frames are accumulated to densify the point clouds, which are then projected into an image plane to generate a depth map for supervision. The Lidar sensor from other frames has a larger displacement from a current camera position, which introduces occlusions when projecting points into the image plane, yielding bogus depth supervision. The present system provides a robust depth supervision scheme to filter out these bogus depths, in a curriculum learning fashion.

Considering that nearby depths are less likely to be occluded, the present embodiments take depth from the near field to supervise NeRF training, and then gradually increase the range as NeRF is in increasingly better shape. Depth points which are far more distant than the NeRF predicted depth are gradually filtered out, which likely indicates that those points are actually occluded points. These two strategies ensure NeRF to be trained with a portion of correct near depths in the beginning, and when NeRF is trained reasonably, it is able to recognize outlier depth points and filter them out. This includes more correct and distant depths over time. Furthermore, with the above robust depth supervision, the training data can be augmented by synthesizing more views using Lidar point clouds by projecting Lidar points to predefined extrapolation views, and assigning red, green, blue (RGB) and depth values to pixels that the points fall into, based on the color and the position of the Lidar point. Note the color of the Lidar point is obtained by projecting to its synchronized camera frame, where occlusion is negligible. The NeRF is trained with the augmented views with the robust depth scheme for further improvement.

The present invention combines different encoding techniques to perform high-quality 3D object NeRF learning with high efficiency. Integrated position encoding is leveraged for distance and scale awareness. Different from the sinusoidal position encoding of a single point in the original NeRF, here each pixel is regarded as a square in an image plane, and then a square patch is projected into 3D, which can be approximated as a 3D cone which is originated at the camera center and expands along the view direction. In this way, each sampling point no longer represents a segment on a ray, but rather a segment on a cone. Note that the volume of this segment depends on its distance to the camera center. Integrated position encoding integrates the sinusoidal position encoding within the segment of the cone where the point resides, thereby enabling scale awareness and preventing aliasing effects.

Embodiments of the present invention fuse features from multiple sources. For Lidar, a deep network is used to extract features for a point cloud, then for each 3D point its features are queried from nearby point clouds. Similarly, for the HD map, 2D convolutional networks are applied to extract a 2D grid of semantic features represented in the bird's eye view, then for each 3D point, the 3D point is projected to a ground plane and the HD map feature is queried. For Hash, a feature grid is learned from scratch following Instant-NPG (Instant Neural Graphics Primitives).

A hash map is used to efficiently generate feature vectors as encoding for each 3D point, following the highly optimized implementation in Instant-NGP. It is computationally infeasible to represent each object with a separable hash grid. Instead, each object is represented as a learnable latent code, and a shared hypernetwork is used to map the latent code to the parameters of the hash grid. Next, we combine the two different kinds of encoding described above and feed them into MLPs for density and color regressing, followed by standard volume rendering to obtain synthesized images of the objects. The NeRF obtained can be used as 3D assets and applied in simulation systems to generate diverse and photo-realistic object image data.

The present embodiments combine scale-away position encoding and highly efficient hash grid encoding for vehicle asset creation in a real driving scene to address the specific challenge emerging in NeRF training for vehicles driving on real roads. In particular, the large scene-to-camera distance and scale variation causes blur and aliasing in rendering. The present invention uses integrated position encoding to solve these problems. To maintain high efficiency despite the large number of objects on the road, the integrated position encoding is combined with hash grid and small MLPs. The combined encodings are then fed to MLPs for density and color regression.

In an embodiment, the present invention provides a hierarchical modelling for a street scene by decomposing the street scene into three hierarchical layers: dynamic vehicles, static background and sky. For the dynamic vehicle layer, the vehicle entities are perceived in bounding boxes (bboxes) as a static bbox, while simulating the vehicle moving by moving the bounding bboxes. This approach permits modeling the dynamic vehicles in the street scene as NeRF. The static background layer encompasses static elements, such as the road, buildings, trees, traffic signs, etc. where we can utilize the NeRF technique. For the sky layer, the sky can be represented with a spherical radiance (environment) map, inspired by the urban field NeRF. The rendered color for sky is independent of the position encoding and only depends on the view direction.

In the rendering process, the hierarchical modelling is leveraged with the priority considering the dynamic vehicle(s) and street scene layers. If a ray has any intersection with the bboxes, (when an intersection is detected), the scene is rendered using the corresponding vehicle NeRF. The static background is rendered with the static background NeRF. These two branches are then merged according to the position and a predicted density value of the sample points. Subsequently, the sky layer is blended into the previous two layers using, e.g., an alpha blending technique. It is assumed that an accumulated weight is a. A rendered color is c=a*c_{vehicle&background}+(1−a)*c_{sky}, where the c_{vehicle&background} stands for the merged color between vehicle and background and c_{sky} represents the color of the sky.

A ‘sky mask’ is introduced as a guidance for the sky modelling. The sky region is segmented out by enforcing (1−a) to be close to 1 at the sky region with a loss. By combining the object bbox modelling and the sky modelling for the street scene rendering, the present invention addresses the specific challenge emerging in NeRF training for real street scenes when modeling the sky and dynamic objects within such environments. The present invention provides an innovative hierarchical modelling strategy to solve this problem.

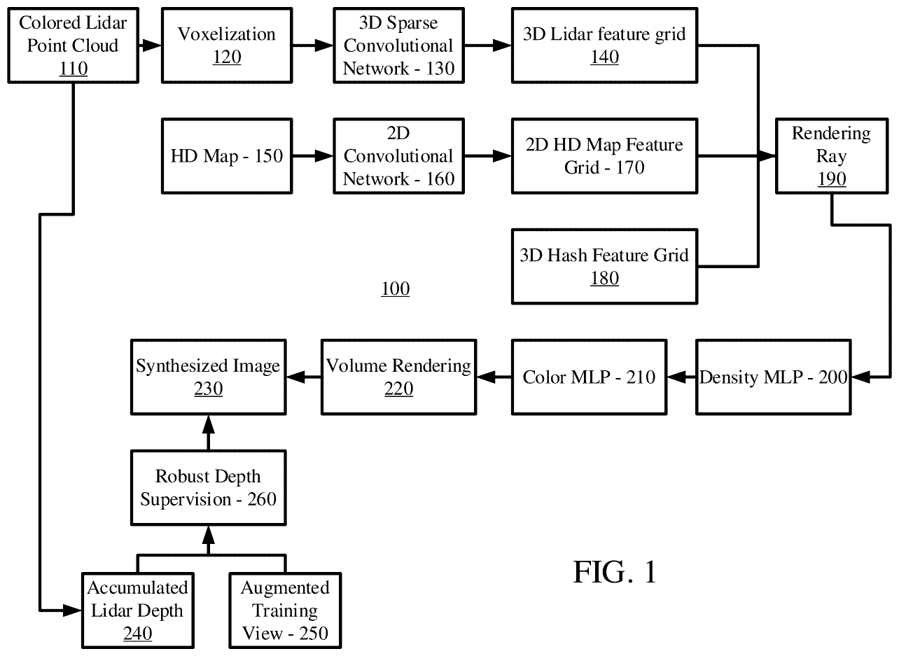

Referring now in detail to the figures in which like-numerals represent the same or similar elements and initially to FIG. 1, a system 100 for novel view synthesis in an image perception environment is described and shown in accordance with embodiments of the present invention.

Neural Radiance Field (NeRF) represents a radiance field with a continuous neural network f:(x,d)→(c,σ), mapping spatial location x=(x,y,z) and viewing direction d=(θ,ϕ) to the RGB color c and volumetric density σ at that point. To render an image, NeRF casts rays through each pixel of the image and samples points along each ray. The network is queried at each point to estimate color and density, which are then composed into the final pixel color using a volume rendering equation. This equation accounts for both the accumulated color along the ray and the probability that the ray travels through the scene without hitting any surfaces. The loss function L_{rgb} is the mean squared error between the predicted and true colors of the training images.

Nerfacto is an approach encompassing a variety of established methods that demonstrate extensive applicability to real-world data. Initial samples are fed into a small proposal network to consolidate the sampled locations along each ray to the regions near the first surface intersection. These samples are passed into a different “nerf” network to predict RGB and density which are rendered into a predicted color the same way as NeRF. They use distortion loss [symbol] dist and interval loss [symbol] interval to supervise the proposal network on the weights from the “Nerfact” Field. For fast inference and training, they use the hash encoding and fused MLPs proposed by Instant-NGP.

A whole scene is separated into a bounded region and an unbounded surrounding space, representing each distinctly. The framework is constructed on the foundational principles of Nerfacto, and can incorporate select modules from its pipeline. The scene contraction technique can be utilized with hash encoding together with fused MLPs to model unbounded surrounding scenes. LiDAR data is leveraged for the representation of the bounded region.

In block 110, a colored light detecting and ranging (Lidar) point cloud is collected from Lidar sensors. The color is obtained by projecting point clouds into images such that corresponding positions in the image are employed to assigned colors to the Lidar point clouds. This includes comparing the Lidar image to the RBG image of a street scene or other image. In block 120, the point cloud is voxelized into a sparse 3D voxel grid. Given the image and Lidar data for a scene, model parameters θ are optimized by minimizing the following loss:

$${ℒ}_{nerfacto} = {ℒ}_{r g b} + λ1 \cdot {ℒ}_{dist} + λ2 \cdot {ℒ}_{i n t e rval}$$

arg min (over θ) [symbol] +λ3· [symbol] +λ4· [symbol] where [symbol] is the Nerfacto loss, [symbol] is the robust depth supervision loss (described herein) and [symbol] is the augmented view supervision loss (described herein).

Lidar features are modeled with 3D sparse convolution. The Lidar encodings are queried on sampled locations with weighted sum of K neighboring Lidar features. Specifically, the static Lidar point cloud is aggregated from each frame to construct a dense 3D scene point cloud and voxelize this point cloud on a voxel grid by averaging multiple points within one voxel cell.

In block 130, a 3D sparse convolutional network is applied to extract geometric features from the Lidar point cloud. A 3D sparse convolution network is an effective and efficient architecture to extract geometric features from Lidar point clouds. It learns the geometric representation from the local and global structure of the scene. Such geometric prior is then fused with existing grid-based representations (parameterized efficiently by a hash map), offering a way to inherit benefits from the explicit point cloud representation. Besides involving Lidar in the input, Lidar is also used more extensively as supervision.

The scene geometry feature is encoded with a 3D sparse convolutional network (e.g., UNet) on the voxel grid. The 3D sparse convolutional network takes input as averaged point coordinates associated with each voxel cell and outputs neural volumetric features. We denote the Lidar embeddings by P={(pᵢ,fᵢ)|i=1, . . . , N}, where each point i is located at pᵢ and associated with a vector fᵢ, which is a neural feature of the closest voxel cell, encoding the global and local 3D geometry around pᵢ.

The present method conducts a query of K Lidar points within a specified search radius R, employing a Fixed Radius Nearest Neighbors (FRNN) approach, establishing a K-nearest Lidar point index set with respect to each sampled location x, denoted as Sₓ^{K}. In instances where the number of Lidar points within a radius R from a sampled position x is fewer than K, the set Sₓ^{K} is set to be empty, which means, Lidar encoding is inapplicable for that particular location. Ray sampling is conducted by FRNN searching online as the sampled locations are generated by a PDF sampler dynamically. An MLP, symbolized by F, is employed to process the ith Lidar embedding to predict a new feature vector for the sampled position x. F outputs the specific neural scene description f_{i,x} at x, modeled by the neural point in its local frame and relative position x−pᵢ:f_{i,x}=F(fᵢ,x−pᵢ)

To obtain the Lidar encoding at sampled location x, denoted as ϕ_{L}(x), we use standard inverse distance weighting to aggregate the neural scene description f_{i,x} from its K neighboring points, conditional upon all K-nearest Lidar points residing within a radius R:

$$\begin{matrix}{ϕ}_{L} ( x ) = \{ \begin{matrix}\frac{{\sum }_{i ϵ {S}_{x}^{K}} {w}_{i} {f}_{i , x}}{{\sum }_{i ϵ {S}_{x}^{K}} {w}_{i}} , if {S}_{x}^{K} is not 0 , \\ \begin{matrix}0 & otherwise .\end{matrix}\end{matrix} \\ {w}_{i} = \frac{1}{‖ {p}_{i} - x ‖}\end{matrix}$$

In cases where Lidar encoding is not feasible, an all-zero dummy feature is substituted. Afterwards, the per-sample density a and density embedding h are predicted from Lidar encoding ϕ_{L}, concatenated with multi-resolution hash encoding ϕₕ by an MLP Fₐ. The corresponding color c is predicted from the direction encoding SH of viewing direction d and density embedding h, via another MLP Fₑ:

a,h=Fₐ(concat(ϕ_{L}(x),ϕₕ(x))),

c=Fₑ(concat(h,SH(d))

Distinct from some other point-based NeRF methodologies, the present approach integrates Lidar geometric encodings with a trainable grid feature. This fusion empowers the present methods to effectively represent areas inadequately covered by point clouds, such as, e.g., high-rise structures in images.

In block 140, a 3D Lidar feature grid is obtained. The 3D sparse convolutional network returns Lidar features as a 3D grid. In block 150, a high-definition (HD) map of the image is obtained. The HD map is taken as input.

In block 160, a 2D convolutional network is applied to extract semantic features from the HD map. In block 170, the 2D convolutional network returns sematic features as a 2D grid represented in a bird's eye view. In block 180, a 3D hash feature grid, which is an original scene representation as a hash feature grid, following Instant-NPG is provided.

In block 190, a rendering ray is generated. View rays are sampled to render the corresponding pixels. Further, points are sampled along the ray to retrieve the corresponding features from blocks 140 (Lidar grid), 170 (HD grid), and 180 (hash feature grid). These features are concatenated, as described above, and passed to block 200. In block 200, an MLP takes the features at a sampled point as input and returns a density at that point as well as a corresponding geometric feature vector. In block 210, an MLP takes the geometric feature vector from block 200 and a viewing direction as input, and returns the color. In block 220, a volume rendering can be provided. The volume rendering can include a standard volume rendering to render pixels for each ray. In block 230, an image is obtained. The image includes an entire synthesized image from the rendering, which is supervised by ground truth during training and/or Lidar depth during training.

In an embodiment, in block 240, an accumulated Lidar depth can be used. Lidar point clouds can be accumulated from multiple nearby frames and then projected to an image plane to generate a depth map. Lidar points are accumulated across nearby frames to generate a denser depth map by projecting them to the image plane.

In block 250, an augmented training view is obtained by projecting the accumulated Lidar point clouds to predefined extrapolated views, yielding augmented training views.

In block 260, a robust depth supervision scheme uses the depth map from block 240 and the augmented training views from block 250 to supervise NeRF training. A simple Z-buffering is not sufficient due to the depth map being not fully dense even with accumulation. To address this, the robust depth supervision scheme provides curriculum learning-supervising depth from near to far field while gradually filtering out bogus depth as the NeRF trains. This further permits generation of augmented training views from Lidar, which can project Lidar points to extrapolated views, which serve as extra training data with the robust depth supervision.

For depth supervision, adjacent Lidar frames are accumulated onto the image plane, generating depth maps D={Dᵢ|i=1, . . . , L}. However, the depth map does not take occlusion into account, resulting in bogus depth supervision. To address this challenge, a robust depth supervision approach is introduced that carefully designs a curriculum from the aspect of sample reliability. A training strategy in accordance with the present embodiments ensures that the model initially trains with closer, more reliable depth data, which are less prone to occlusion. As training progresses, the model gradually begins to incorporate more distant depth data. Concurrently, the model develops the capacity to discard depth supervisions that are anomalously distant compared to its predictions.

Specifically, in the mth training iteration, valid depth samples D_{robust}^{m} are governed by two scheduled parameters: valid depth threshold ϵ^{m}_{d} and valid depth offset

$$\begin{matrix}{𝒟}_{robust}^{m} = \{ {𝒟}_{i , j} \vert {𝒟}_{i , j} \leq {ϵ}_{d}^{m} ⋂ {𝒟}_{i , j} - {\hat{𝒟}}_{i , j} \leq {ϵ}_{d}^{m} ⋂ {𝒟}_{i , j} ∈ 𝒟 \} \\ {ϵ}_{d}^{m} = min \{ {α}^{m} {ϵ}_{o}^{d} , {ϵ}_{d}^{T} \} , {ϵ}_{o}^{m} = min \{ {α}^{m} {ϵ}_{o}^{0} , {ϵ}_{o}^{T} \}\end{matrix}$$

The parameter ϵ_{d} serves to filter out depth samples D_{i,j}, that exceed this threshold, thereby prioritizing nearer depth samples which are less likely to be occluded. Initially, the model employs a lower value for ϵ_{d}, focusing on training with these closer, more accurate depth samples. As training progresses, ϵ_{d} is exponentially increased at a rate of α_{d}, and more distance depth samples can be involved in depth supervision. Meanwhile, depth samples exhibiting a discrepancy greater than co when compared to the predicted depth \hat{D}_{i,j} are omitted. The tolerance value co is set to decay exponentially at a rate of α₀, aligning with the improvement of depth predictions over the course of training. By this end,

Within the robust depth supervision scheme, pixel-level depth loss is adopted. In addition, to an L2 loss, [symbol] between the rendered depth and the ground truth, a line-of-sight loss [symbol] sight involving [symbol] empty and [symbol] near is applied to further constrain each sampling point individually. Specifically, [symbol] enforces the weight distribution to resemble a Gaussian distribution centered at the ground truth depth along a rendering ray. For each pixel, this loss is written as

$${ℒ}_{near} = {𝔼}_{r \sim 𝒟} [ {\int }_{{t}_{near}}^{{t}_{far}} {( w ( t ) - 𝒩 ( \tilde{z} , {ϵ}_{n} ) )}^{2} dt ]$$

Since the weight w is computed on discrete intervals given by point sampling in NeRF, this loss is discretized to:

[symbol] = [symbol] [Σᵢ(wᵢ− [symbol] )²] where Nᵢ indicates the probability mass within interval i. Here, a possible implementation (e.g., in NerfStudio) to obtain Nᵢ is by mid-point approximation. However, this approximation is unnecessary for a Gaussian distribution as its probability mass can be obtained through its tabulated cumulative distribution function (CDF). [symbol] can be employed for [symbol] (the robust depth supervision loss).

To improve photorealism at extrapolated viewpoints, the present methods augment training data by projecting Lidar colors and spatial coordinates onto a set of synthetically augmented views. Each visible Lidar point is assigned RGB values interpolated from its nearest RGB frame's corresponding pixel location. These augmented training views are derived from existing ones, by maintaining directional consistency while introducing stochastic perturbations to their centers, with scale ϵₐ∈ [symbol] (0,ϵₐ). Such augmented data fail to account for potential occlusions. The present model, fortified by robust depth supervision, is adept at discerning and excluding occluded Lidar points on the fly. Initially, the model undergoes pre-training using raw training views to establish an accurate depth estimation. Subsequently, the model is finetuned with the augmented dataset, disregarding any pixels whose depth exceeds the predicted model depth by a margin of co, thereby ensuring the reliability of the training process. [symbol] is the augmented view supervision loss used for optimization.

In an embodiment, dynamic objects are masked from RGB images with dataset bounding box annotations and instance segmentation models. Static Lidar points are obtained by removing the points within the 3D bounding boxes of dynamic objects, provided by datasets. A CUDA-implemented FRNN search algorithm can be employed to query, e.g., 10 nearest Lidar points within a radius, e.g., 0.3 meters. In terms of loss weights, the following can be employed and adjusted as needed: λ₁=0.0005, λ₂=1, λ₃=0.005 and λ₄=1. We set all σs in the unnormalized scale.

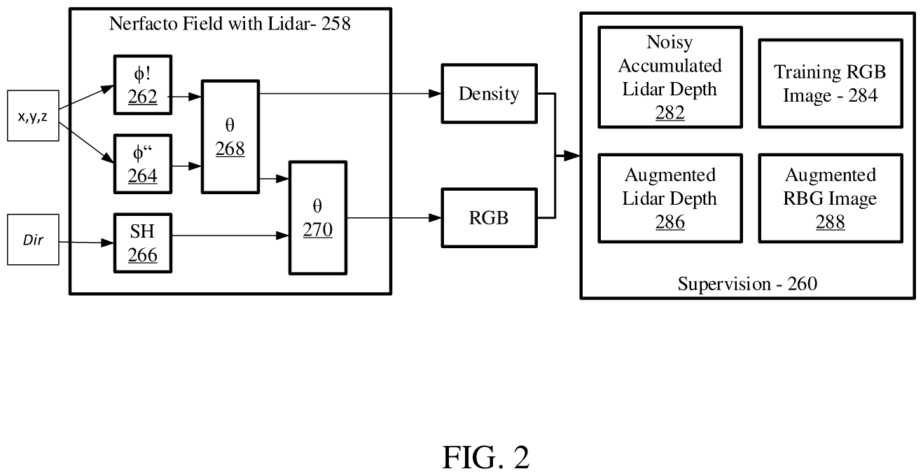

Referring to FIG. 2, in accordance with embodiments of the present invention, systems and methods employ NeRF to develop a fully automatic pipeline for image simulation. The present systems take as input real driving logs, build a 3D digital twin (e.g., 3D reconstruction with NeRF) for captured scenes, edit the digital twin to generate diverse virtual scenarios, and conduct novel view synthesis through differentiable rendering to simulate image data.

A ray bundle is received from an image and deep neural networks are applied to extract geometry features and semantic features from Lidar and HD maps, respectively. For Lidar, point clouds are voxelized into sparse voxels and a 3D sparse convolutional network is applied to extract a 3D grid of geometry features (x, y, z) and direction (dir) direction of a ray. For the HD map, 2D convolutional networks are applied to extract a 2D grid of semantic features represented in a bird's eye view.

A NeRF representation 258 (Nerfacto field) in accordance with embodiments of the present invention is employed as a component which receive geometric feature vectors and the viewing ray directions. The geometric feature vectors are input to hash encoding 262 and Lidar encoding 264 and viewing ray direction is input to spherical harmonics encoding 266. NeRF representation 258 lies in a hash grid that efficiently maps each 3D point into a feature vector, which are then passed to multi-layer perceptrons (MLPs) 268 and 270 for decoding density and color, and then volume rendering (260) follows to synthesize images from novel views. Besides the original features from the hash grid, features from the Lidar feature gird are additionally retrieved as well as the HD map feature grid. These features are concatenated with the hash grid feature before being fed to the MLPs 268, 270. In this way, NeRF training is supplied with rich geometry and semantic prior of the scene, leading to improved view extrapolation performance.

The present systems enable view extrapolation capability in image simulation under driving scenes. Lidar and HD maps are leveraged with Lidar as geometry supervision through a depth loss during NeRF training. The system framework takes Lidar as input to the NeRF network, which utilizes the Lidar sensor to paint the Lidar with color by projecting point clouds into image planes captured by the camera and retrieving color from the corresponding pixels. This associates the geometry with color and further facilitates the rendering task. Furthermore, the HD map is utilized in a NeRF framework to improve novel view synthesis in driving scenes and leverage the semantic prior in the HD map to enable high-quality rendering in extrapolated novel views.

Lidar is used as depth supervision for NeRF training. Due to the sparse nature of Lidar point clouds, multiple nearby frames are accumulated to densify the point clouds, which are then projected into an image plane to generate a depth map for supervision. The Lidar sensor from other frames has a larger displacement from a current camera position, which introduces occlusions when projecting points into the image plane, yielding bogus depth supervision. The present system provides a robust depth supervision scheme to filter out these bogus depths, in a curriculum learning fashion.

Considering that nearby depths are less likely to be occluded, the present embodiments take depth from the near field to supervise NeRF training, and then gradually increase the range as NeRF is in increasingly better shape. A volumetric renderer 260 employs supervision to provide highly accurate renderings. The supervised training includes noisy accumulated Lidar depth in block 282, RBG image training data in block 284, augmented Lidar depth in block 286 and augmented RBG image data in block 284.

Depth points which are far more distant than the NeRF predicted depth are gradually filtered out, which likely indicates that those points are actually occluded points. These two strategies ensure NeRF to be trained with a portion of correct near depths in the beginning, and when NeRF is trained reasonably, it is able to recognize outlier depth points and filter them out. This includes more correct and distant depths over time. Furthermore, with the above robust depth supervision, the training data can be augmented by synthesizing more views using Lidar point clouds by projecting Lidar points to predefined extrapolation views, and assigning red, green, blue (RGB) and depth values to pixels that the points fall into, based on the color and the position of the Lidar point. Note the color of the Lidar point is obtained by projecting to its synchronized camera frame, where occlusion is negligible. The NeRF is trained with the augmented views with the robust depth scheme for further improvement.

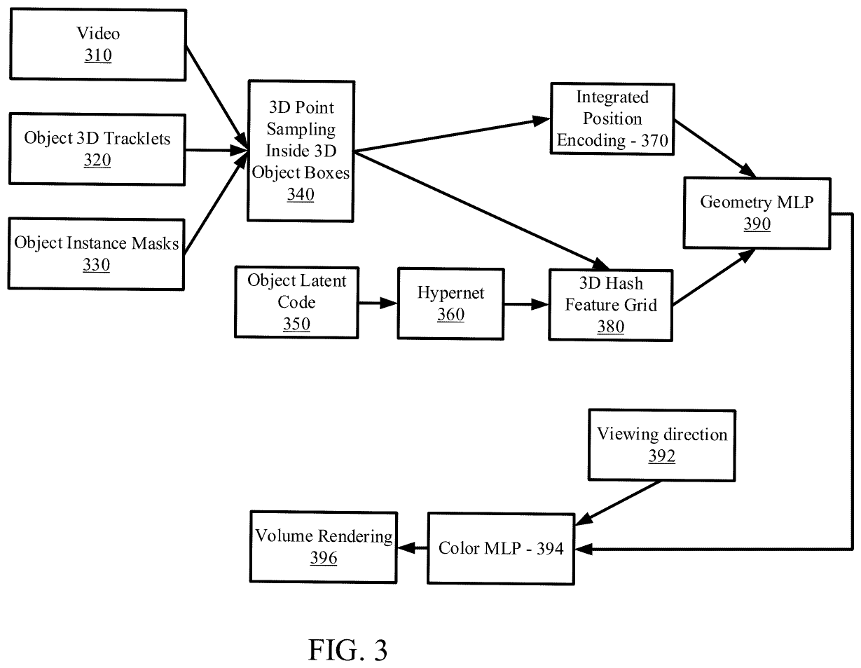

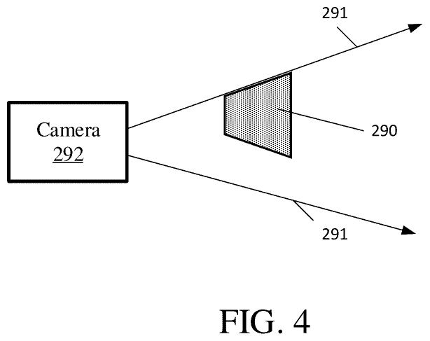

Referring to FIG. 3, in another embodiment, different encoding techniques are combined to perform high-quality 3D object NeRF learning with high efficiency. Integrated position encoding is leveraged for distance and scale awareness. Different from the sinusoidal position encoding of a single point in the original NeRF, here each pixel is regarded as a square in an image plane, and then a square patch is projected into 3D, which can be approximated as a 3D cone which is originated at the camera center and expands along the view direction with rays 291. This is illustrated in FIG. 4, which shows a sampling point segment 290 (depicted in 2D) relative to a camera 292, which can be approximated as a 3D cone.

In this way, each sampling point no longer represents a segment on a ray, but rather a segment on a cone. Note that the volume of this segment depends on its distance to the camera center. Integrated position encoding integrates sinusoidal position encoding within the segment of the cone where the point resides, thereby enabling scale awareness and preventing aliasing effects. This imports depth to any rendered synthesized image.

A hash map is used to efficiently generate feature vectors as encoding for each 3D point, following the highly optimized implementation in Instant-NGP. It is computationally infeasible to represent each object with a separable hash grid. Instead, each object is represented as a learnable latent code, and a shared hypernetwork is used to map the latent code to the parameters of the hash grid. Compare semantic and latent codes. Semantic codes capture a surface, obvious or explicit meaning in data, whereas latent codes capture underlying or implicit meanings. These implicit meanings can allow more obvious meanings to make sense. Next, two different kinds of encoding are combined and fed into MLPs for density and color regressing, followed by volume rendering to obtain synthesized images of the objects.

In block 310, a video sequence is captured in, e.g., a driving scene, as input. In block 320, object 3D tracklets, which provide tracking information for moving objects in the scene are detected in the image. The present system takes tracked 3D object boxes as input. In block 330, object instance masks are generated. Masks can be generated to remove objects or portions of a scene. The system also takes instance segmentation masks for the object in the video as input. In block 340, 3D point sampling inside the 3D object boxes is performed. For each pixel in the training image, the system back-projects into a viewing ray in the 3D space using camera extrinsic and intrinsic parameters. An intersection is computed between the ray and the 3D object boxes and in particular between sample 3D points along the ray interval inside the object box.

In block 350, each object is represented as a learnable latent code. Latent code captures underlying or implicit meanings of each object providing additional information about the object (its structure, etc.). In block 360, a hypernetwork takes the object latent code as input and outputs a parameter for a 3D hash feature grid. Hypernetworks, or hypernets, are neural networks that generate weights for another neural network, known as the target network. The hypernetwork provides a deep learning technique that allows for faster training and model compression.

In block 370, position encoding is integrated. This is a distance and scale aware position encoding where a sinusoidal position encoding is integrated over the corresponding space in a view frustrum. A size of this space depends on the viewing distance, hence achieving a distance aware property (e.g., using conical shaped samples described above).

In block 380, a 3D hash feature grid (hash map) is generated. This can be a standard hash feature grid as in Instant-NPG. A hash map allows efficient generation of feature grids which are then decoded into density and color. In block 390, a geometry MLP is employed to concatenate the integrated position encoding from block 370 and the hash map from block 380. These are fed into the geometry MLP for regressing density and a vector of a geometric feature (geometric feature vector).

In block 392, a viewing direction the ray, which is used to capture a view-dependent effect is defined. In block 394, the viewing direction and the geometric feature vector returned from block 390 are fed into a color MLP for regressing the color at that point. In block 396, a volume rendering is performed. The density and color along the rendering ray are collected to perform standard volume rendering, yielding a synthesized image.

In another embodiment, the present invention provides hierarchical modelling for a street scene by decomposing the street scene into three hierarchical layers: dynamic vehicles, static background and sky. For the dynamic vehicle layer, the vehicle entities are perceived in bounding boxes (bboxes) as a static bbox, while simulating the vehicle moving by moving the bounding bboxes. This approach permits modeling the dynamic vehicles in the street scene as NeRF. The static background layer encompasses static elements, such as the road, buildings, trees, traffic signs, etc. where we can utilize the NeRF technique. For the sky layer, the sky can be represented with a spherical radiance (environment) map, inspired by the urban field NeRF. The rendered color for sky is independent of the position encoding and only depends on the view direction.

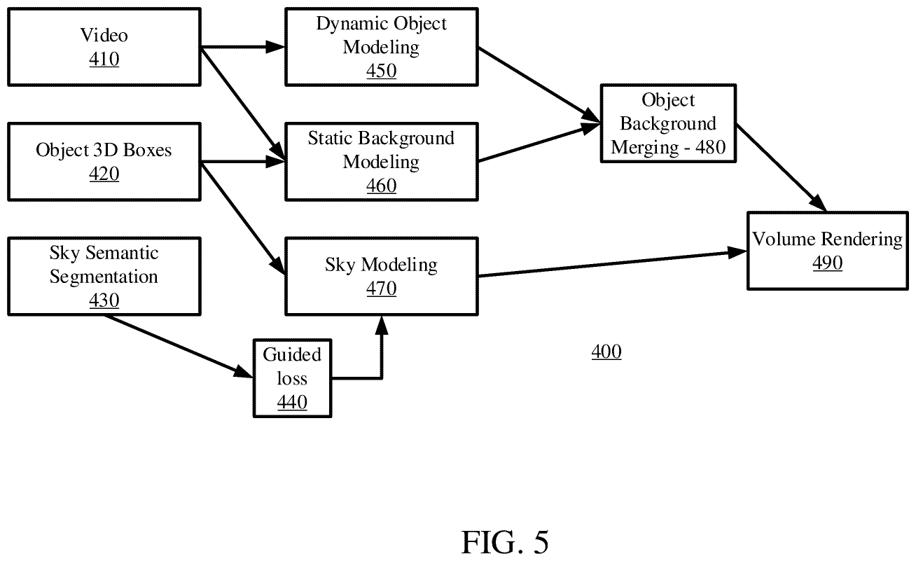

Referring to FIG. 5, a system 400 is shown for modeling a scene while accounting for the sky in accordance with embodiments of the present invention.

In block 410, a video sequence is captured in a real street scene as input to the system 400. In block 420, bounding boxes or object 3D boxes are generated around a vehicle or other objects in the scene. The system takes the 3D bounding boxes for the vehicle as input. In block 430, the system also takes a semantic segmentation map of the sky region as the input for sky semantic segmentation.

In an embodiment, the present invention provides a hierarchical modelling for a street scene by decomposing the street scene into three hierarchical layers: dynamic vehicles, static background and sky. For the dynamic vehicle layer, the vehicle entities are perceived in bounding boxes (bboxes) as a static bbox, while simulating the vehicle moving by moving the bounding bboxes. This approach permits modeling the dynamic vehicles in the street scene as NeRF. The static background layer encompasses static elements, such as the road, buildings, trees, traffic signs, etc. where we can utilize the NeRF technique. For the sky layer, the sky can be represented with a spherical radiance (environment) map, inspired by the urban field NeRF. The rendered color for sky is independent of position encoding and only depends on the view direction.

In block 440, guided loss is determined. The guided loss takes sky semantic segmentation as input and enforces a model to adapt sky modeling at the sky region. Specifically, it enforces the weight of the sky modeling to be large at the sky region. In block 450, dynamic object modelling is performed to model the moving objects in the scene. The system models the dynamic objects as a static object in moving bounding boxes, enabling the use of NeRF for modeling moving vehicles.

In block 460, static background modeling is performed for background objects, e.g., road, buildings, traffic signs, trees, etc. The static background is also modeled with NeRF. In block 470, sky modeling is performed. The sky is modeled with a sphere radiance model that only depends on ray direction. This employs sphere harmonics encoding which can be merged (see e.g., FIG. 2).

In block 480, object background merging is performed. This merges the dynamic objects and static background according to a density and color of sampled points along the ray. In block 490, volume rendering is performed. This merges the three layers: dynamic object, static scene and sky background together and renders a simulated image.

In the rendering process, the hierarchical modelling is leveraged with the priority considering the dynamic vehicle(s) and street scene layers. If a ray has any intersection with the bboxes, (when an intersection is detected), the scene is rendered using the corresponding vehicle NeRF. The static background is rendered with the static background NeRF. These two branches are then merged according to the position and a predicted density value of the sample points. Subsequently, the sky layer is blended into the previous two layers using, e.g., an alpha blending technique. It is assumed that an accumulated weight is a. A rendered color is c=a*c_{vehicle&background}+(1−a)*c_{sky}, where the c_{vehicle&background} stands for the merged color between vehicle and background and c_{sky} represents the color of the sky.

A ‘sky mask’ can be introduced as a guidance for the sky modelling. The sky region is segmented out by enforcing (1−a) to be close to 1 at the sky region with a loss. By combining the object bbox modelling and the sky modelling for the street scene rendering, the present invention addresses the specific challenge emerging in NeRF training for real street scenes when modeling the sky and dynamic objects within such environments. The present invention provides an innovative hierarchical modelling strategy to solve this problem.

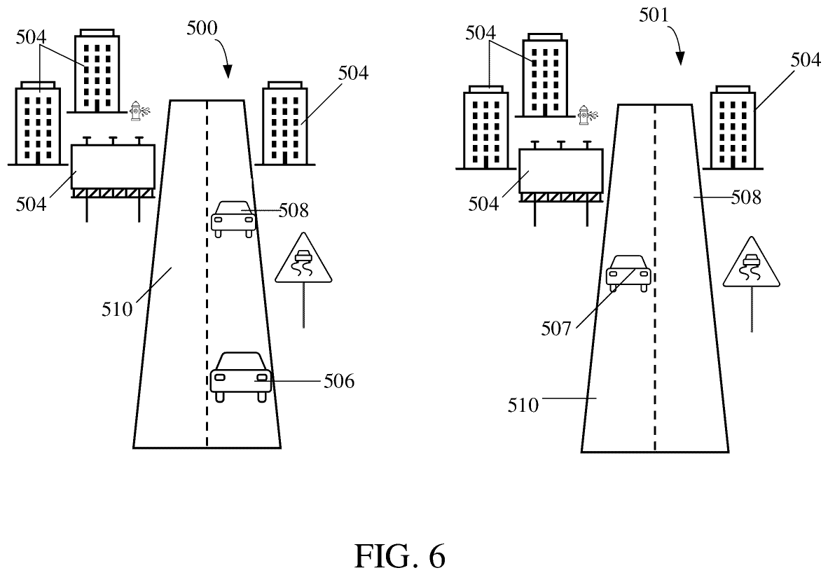

FIG. 6 shows an example of a synthesized image generated in accordance with systems described herein. A scene of a reference image 500 includes buildings 504 or other structures and a number of vehicles 506 and 508, which can be in motion. A synthesized image 501 generated in accordance with the present embodiments includes images of a vehicle 507 that accounts for depth to accurately portray a realistic image of static objects, dynamic objects and accurately accounts for the sky background. Here, the vehicle 507 is generated on the left side of a road 510 at a different depth when compared to the vehicles 506, 508 of the reference image 500. By being able to generate synthetic images with accurate depth, model training data can more easily be generated with labels without human interaction.

Synthetic images can be employed for training systems with little human intervention. Synthetic images can enable self-training and help to account for novel occurrences and objects in a scene.

After collecting the data, model training occurs using the data collected. The model training includes training an initial perception model. The perception model can include sensor fusion data, which merges data from at least two sensors. Perception refers to the processing and interpretation of sensor data to detect, identify, track and classify objects. Sensor fusion and perception enable, e.g., an automated driver assistance system (ADAS) to develop a 2D or 3D model of the surrounding environment that feeds into a control unit for a vehicle. Other applications can include inspection machines in a manufacturing environment, computer visions, cyber security applications, etc. The perception model can also include bird's eye view (BEV) perspectives as trajectory predictions. Trajectory prediction includes information for predicting short-term (1-3 seconds) and long-term (3-5 seconds) spatial coordinates of various vehicles or objects, e.g., cars, pedestrians, etc.

As employed herein, multilayer perceptrons (MLPs) have been described to provide a feedforward artificial neural network, consisting of fully connected neurons to distinguish data. While MLPs are described, other artificial machine learning systems can also be employed in accordance with embodiments of the present invention to predict outputs or outcomes based on input data, e.g., image data. In an example, given a set of input data, a machine learning system can predict an outcome. The machine learning system will likely have been trained on much training data in order to generate its model. It will then predict the outcome based on the model.

In some embodiments, the artificial machine learning system includes an artificial neural network (ANN). One element of ANNs is the structure of the information processing system, which includes a large number of highly interconnected processing elements (called “neurons”) working in parallel to solve specific problems. ANNs are furthermore trained using a set of training data, with learning that involves adjustments to weights that exist between the neurons. An ANN is configured for a specific application, such as pattern recognition or data classification, through such a learning process.

The present embodiments may take any appropriate form, including any number of layers and any pattern or patterns of connections therebetween. ANNs demonstrate an ability to derive meaning from complicated or imprecise data and can be used to extract patterns and detect trends that are too complex to be detected by humans or other computer-based systems. The structure of a neural network is known generally to have input neurons that provide information to one or more “hidden” neurons. Connections between the input neurons and hidden neurons are weighted, and these weighted inputs are then processed by the hidden neurons according to some function in the hidden neurons. There can be any number of layers of hidden neurons, and as well as neurons that perform different functions. There exist different neural network structures as well, such as a convolutional neural network, a maxout network, etc., which may vary according to the structure and function of the hidden layers, as well as the pattern of weights between the layers. The individual layers may perform particular functions, and may include convolutional layers, pooling layers, fully connected layers, softmax layers, or any other appropriate type of neural network layer. A set of output neurons accepts and processes weighted input from the last set of hidden neurons.

This represents a “feed-forward” computation, where information propagates from input neurons to the output neurons. Upon completion of a feed-forward computation, the output is compared to a desired output available from training data. The error relative to the training data is then processed in “backpropagation” computation, where the hidden neurons and input neurons receive information regarding the error propagating backward from the output neurons. Once the backward error propagation has been completed, weight updates are performed, with the weighted connections being updated to account for the received error. It should be noted that the three modes of operation, feed forward, back propagation, and weight update, do not overlap with one another. This represents just one variety of ANN computation, and that any appropriate form of computation may be used instead. In the present case the output neurons provide emission information for a given plot of land provided from the input of satellite or other image data.

To train an ANN, training data can be divided into a training set and a testing set. The training data includes pairs of an input and a known output. During training, the inputs of the training set are fed into the ANN using feed-forward propagation. After each input, the output of the ANN is compared to the respective known output or target. Discrepancies between the output of the ANN and the known output that is associated with that particular input are used to generate an error value, which may be backpropagated through the ANN, after which the weight values of the ANN may be updated. This process continues until the pairs in the training set are exhausted.

After the training has been completed, the ANN may be tested against the testing set or target, to ensure that the training has not resulted in overfitting. If the ANN can generalize to new inputs, beyond those which it was already trained on, then it is ready for use. If the ANN does not accurately reproduce the known outputs of the testing set, then additional training data may be needed, or hyperparameters of the ANN may need to be adjusted.

ANNs may be implemented in software, hardware, or a combination of the two. For example, each weight may be characterized as a weight value that is stored in a computer memory, and the activation function of each neuron may be implemented by a computer processor. The weight value may store any appropriate data value, such as a real number, a binary value, or a value selected from a fixed number of possibilities, which is multiplied against the relevant neuron outputs. Alternatively, the weights may be implemented as resistive processing units (RPUs), generating a predictable current output when an input voltage is applied in accordance with a settable resistance.

A neural network becomes trained by exposure to empirical data. During training, the neural network stores and adjusts a plurality of weights that are applied to the incoming empirical data. By applying the adjusted weights to the data, the data can be identified as belonging to a particular predefined class from a set of classes or a probability that the input data belongs to each of the classes can be output.

The empirical data, also known as training data, from a set of examples can be formatted as a string of values and fed into the input of the neural network. Each example may be associated with a known result or output. Each example can be represented as a pair, (x, y), where x represents the input data and y represents the known output. The input data may include a variety of different data types, and may include multiple distinct values. The network can have one input node for each value making up the example's input data, and a separate weight can be applied to each input value. The input data can, for example, be formatted as a vector, an array, or a string depending on the architecture of the neural network being constructed and trained.

The neural network “learns” by comparing the neural network output generated from the input data to the known values of the examples, and adjusting the stored weights to minimize the differences between the output values and the known values. The adjustments may be made to the stored weights through back propagation, where the effect of the weights on the output values may be determined by calculating the mathematical gradient and adjusting the weights in a manner that shifts the output towards a minimum difference. This optimization, referred to as a gradient descent approach, is a non-limiting example of how training may be performed. A subset of examples with known values that were not used for training can be used to test and validate the accuracy of the neural network.

During operation, the trained neural network can be used on new data that was not previously used in training or validation through generalization. The adjusted weights of the neural network can be applied to the new data, where the weights estimate a function developed from the training examples. The parameters of the estimated function which are captured by the weights are based on statistical inference.

A deep neural network, such as a multilayer perceptron, can have an input layer of source nodes, one or more computation layer(s) having one or more computation nodes, and an output layer, where there is a single output node for each possible category into which the input example could be classified. An input layer can have a number of source nodes equal to the number of data values in the input data. The computation nodes in the computation layer(s) can also be referred to as hidden layers because they are between the source nodes and output node(s) and are not directly observed. Each node in a computation layer generates a linear combination of weighted values from the values output from the nodes in a previous layer, and applies a non-linear activation function that is differentiable over the range of the linear combination. The weights applied to the value from each previous node can be denoted, for example, by w₁, w₂, . . . wₙ₋₁, wₙ. The output layer provides the overall response of the network to the input data. A deep neural network can be fully connected, where each node in a computational layer is connected to all other nodes in the previous layer, or may have other configurations of connections between layers. If links between nodes are missing, the network is referred to as partially connected.

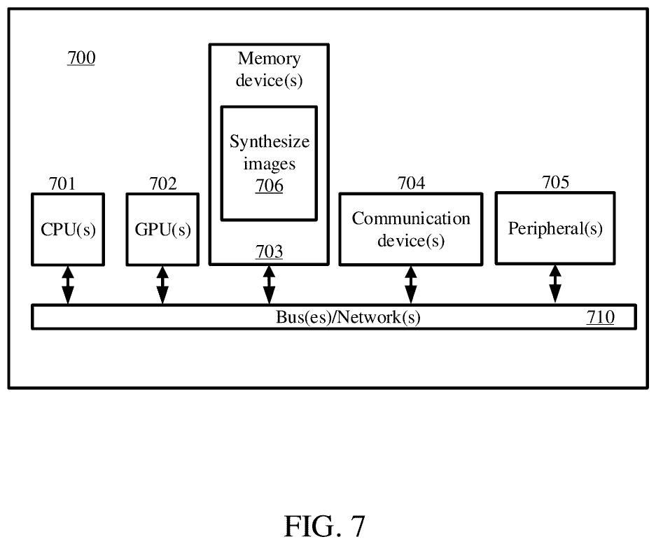

Referring to FIG. 7, a block diagram is shown for an exemplary processing system 700, in accordance with an embodiment of the present invention. The processing system 700 includes a set of processing units (e.g., CPUs) 701, a set of GPUs 702, a set of memory devices 703, a set of communication devices 704, and a set of peripherals 705. The CPUs 701 can be single or multi-core CPUs. The GPUs 702 can be single or multi-core GPUs. The one or more memory devices 703 can include caches, RAMs, ROMs, and other memories (flash, optical, magnetic, etc.). The communication devices 704 can include wireless and/or wired communication devices (e.g., network (e.g., WIFI, etc.) adapters, etc.). The peripherals 705 can include a display device, a user input device, a printer, an imaging device, and so forth. Elements of processing system 700 are connected by one or more buses or networks (collectively denoted by the figure reference numeral 710).

In an embodiment, memory devices 703 can store specially programmed software modules to transform the computer processing system into a special purpose computer configured to implement various aspects of the present invention. In an embodiment, special purpose hardware (e.g., Application Specific Integrated Circuits, Field Programmable Gate Arrays (FPGAs), and so forth) can be used to implement various aspects of the present invention.

In an embodiment, memory devices 703 store program code for implementing one or more functions of the systems and methods described herein for synthesizing images 706). The memory devices 703 can store program code for implementing one or more functions of the systems and methods described herein.

Of course, the processing system 700 may also include other elements (not shown), as readily contemplated by one of skill in the art, as well as omitting certain elements. For example, various other input devices and/or output devices can be included in processing system 700, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized. These and other variations of the processing system 700 are readily contemplated by one of ordinary skill in the art given the teachings of the present invention provided herein.

Moreover, it is to be appreciated that various figures as described with respect to various elements and steps relating to the present invention that may be implemented, in whole or in part, by one or more of the elements of system 700.

Embodiments described herein may be entirely hardware, entirely software or including both hardware and software elements. In a preferred embodiment, the present invention is implemented in software, which includes but is not limited to firmware, resident software, microcode, etc.

Embodiments may include a computer program product accessible from a computer-usable or computer-readable medium providing program code for use by or in connection with a computer or any instruction execution system. A computer-usable or computer readable medium may include any apparatus that stores, communicates, propagates, or transports the program for use by or in connection with the instruction execution system, apparatus, or device. The medium can be magnetic, optical, electronic, electromagnetic, infrared, or semiconductor system (or apparatus or device) or a propagation medium. The medium may include a computer-readable storage medium such as a semiconductor or solid state memory, magnetic tape, a removable computer diskette, a random access memory (RAM), a read-only memory (ROM), a rigid magnetic disk and an optical disk, etc.

Each computer program may be tangibly stored in a machine-readable storage media or device (e.g., program memory or magnetic disk) readable by a general or special purpose programmable computer, for configuring and controlling operation of a computer when the storage media or device is read by the computer to perform the procedures described herein. The inventive system may also be considered to be embodied in a computer-readable storage medium, configured with a computer program, where the storage medium so configured causes a computer to operate in a specific and predefined manner to perform the functions described herein.

A data processing system suitable for storing and/or executing program code may include at least one processor coupled directly or indirectly to memory elements through a system bus. The memory elements can include local memory employed during actual execution of the program code, bulk storage, and cache memories which provide temporary storage of at least some program code to reduce the number of times code is retrieved from bulk storage during execution. Input/output or I/O devices (including but not limited to keyboards, displays, pointing devices, etc.) may be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

As employed herein, the term “hardware processor subsystem” or “hardware processor” can refer to a processor, memory, software or combinations thereof that cooperate to perform one or more specific tasks. In useful embodiments, the hardware processor subsystem can include one or more data processing elements (e.g., logic circuits, processing circuits, instruction execution devices, etc.). The one or more data processing elements can be included in a central processing unit, a graphics processing unit, and/or a separate processor- or computing element-based controller (e.g., logic gates, etc.). The hardware processor subsystem can include one or more on-board memories (e.g., caches, dedicated memory arrays, read only memory, etc.). In some embodiments, the hardware processor subsystem can include one or more memories that can be on or off board or that can be dedicated for use by the hardware processor subsystem (e.g., ROM, RAM, basic input/output system (BIOS), etc.).

In some embodiments, the hardware processor subsystem can include and execute one or more software elements. The one or more software elements can include an operating system and/or one or more applications and/or specific code to achieve a specified result.

In other embodiments, the hardware processor subsystem can include dedicated, specialized circuitry that performs one or more electronic processing functions to achieve a specified result. Such circuitry can include one or more application-specific integrated circuits (ASICs), field-programmable gate arrays (FPGAs), and/or programmable logic arrays (PLAs).

These and other variations of a hardware processor subsystem are also contemplated in accordance with embodiments of the present invention.

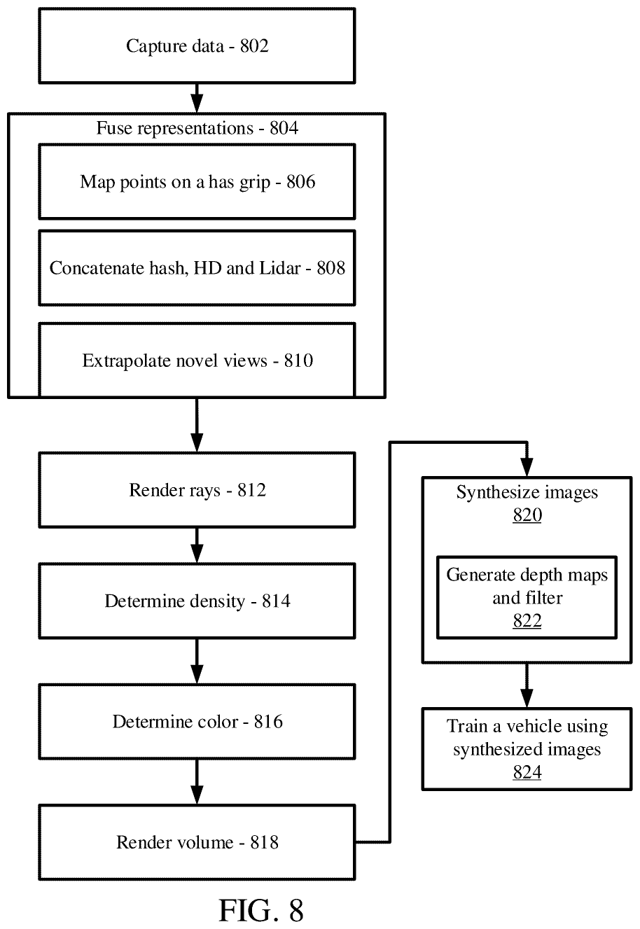

Referring to FIG. 8, a computer-implemented method for synthesizing an image is described in accordance with embodiments of the present invention. These methods are particularly useful for background images. In block 802, data is captured from a scene, e.g., a driving scene or image. In block 804, grid-based representations of the scene are fused from a plurality of different encodings to inherit beneficial properties of the different encodings, the plurality of encodings including at least Lidar encoding and a high definition map encoding.

In block 806, three-dimensional points can be mapped into features vectors with a hash grid. In block 808, fusing the grid-based representations can include concatenating the hash grid, a grid of the Lidar encoding and a grid of the high definition map. In block 810, novel views can be extrapolated from concatenated information of the hash grid, the grid of the Lidar encoding and the grid of the high definition map.

In block 812, view rays are rendered from fused grid-based representations. In block 814, a density for points in the rays are determined. This can include decoding the density using a multi-layer perceptron. In block 816, a color for the points in the rays are determined. This can include decoding color using a multi-layer perceptron.

In block 818, the rays are volume rendered with the density and color information. In block 820, an image or images are synthesized from volume rendered rays with the density and the color. In block 822, depth maps can be generated and data filtered in the depth maps using a depth threshold and depth offset to prioritize nearer depth samples during training to reduce depth occlusion in the image. In block 824, a self-driving vehicle can be trained using synthesized images from the volume rendered rays. The process can be iterated to continually improve the models and performance.

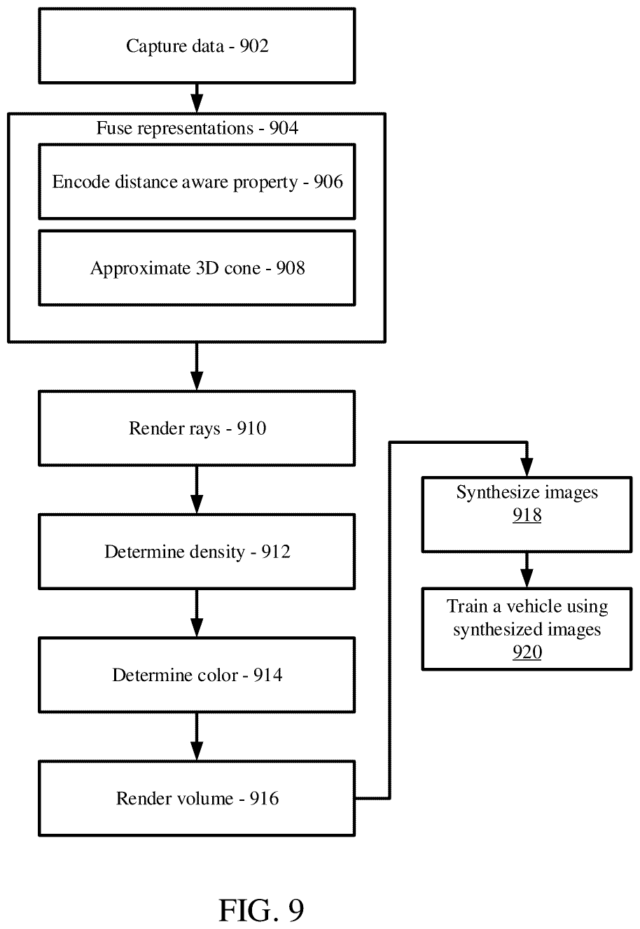

Referring to FIG. 9, another method for synthesizing objects in an image includes capturing data from a scene in block 902. In block 904, representations from a plurality of different encodings are fused to inherit beneficial properties of the different encodings, the plurality of encodings including positioning encoding wherein the positioning encoding provides a distance aware property. In block 906, the positioning encoding can include projecting pixels of an image that expand along a view direction to encode the distance aware property. In block 908, the pixels expand along a view direction can be approximated as a three-dimensional cone. The cone include a geometry that indicate a direction. This directional nature of the cone provide distance awareness since the cone has a larger end and a smaller end.

In block 910, rays from fused representations are rendered. In block 912, a density for points in the rays is determined. In block 914, a color for the points in the rays can be determined. In block 916, the rays with the density and color are volume rendered. In block 918, an image or images are synthesized from the volume rendered rays with density and color in accordance with distance aware property. In block 920, a self-driving vehicle can be trained using synthesized images from the volume rendered rays. The process can be iterated to continually improve the models and performance.

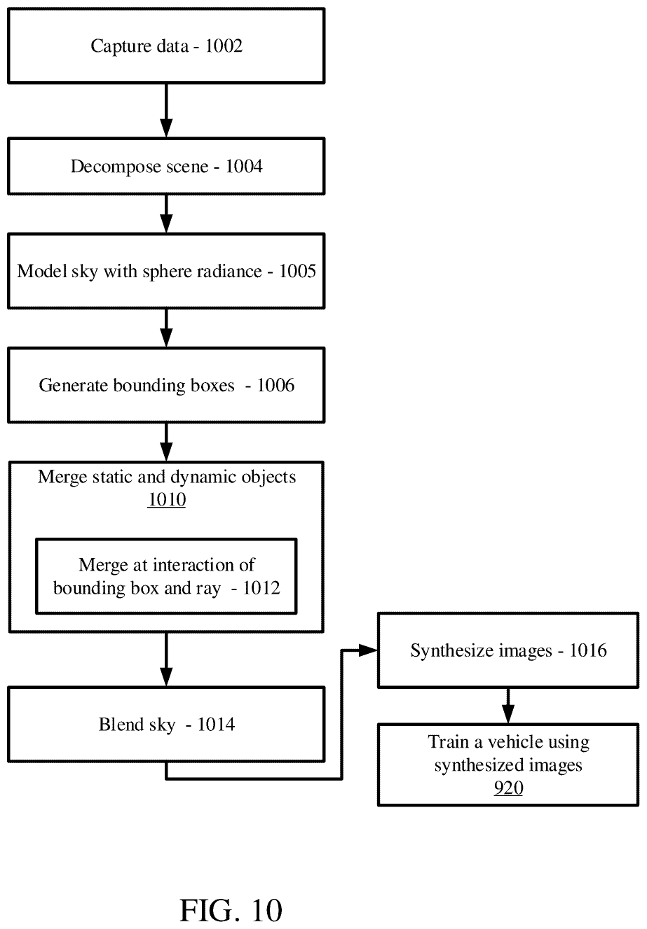

Referring to FIG. 10, another method for synthesizing an image includes capturing data from a scene in block 1002. In block 1004, the scene is decomposed into static objects, dynamic objects and sky. In block 1005, the sky can be modeled using a sphere radiance model.

In block 1006, bounding boxes are generated for the dynamic objects. In block 1008, motion of the dynamic objects is simulated as static with movement of the bounding boxes. This permits the dynamic objects to be encoded using NeRF and therefore are compatible with the static objects encoded using NeRF.

In block 1010, the dynamic objects and the static objects are merged according to density and color of sample points. In block 1012, a scene is rendered for merging dynamic objects and the static objects when an intersection between a bounding box of a dynamic object and a ray view direction occurs.

In block 1014, the sky is blended into a merged version of the dynamic objects and the static objects. In an embodiment, alpha blending can be employed. A rendered color in an image can include c=a*c_{vehicle&background}+(1−a)*c_{sky}, where a is accumulated weight, c_{vehicle&background} is a merged color between a vehicle and background and C sky represents the color of the sky wherein a sky region is segmented out by enforcing (1-a) to be close to 1 at the sky region with a loss.

In block 1016, an image is synthesized from volume rendered rays. In block 1018, a self-driving vehicle can be trained using synthesized images from the volume rendered rays. The process can be iterated to continually improve the models and performance.

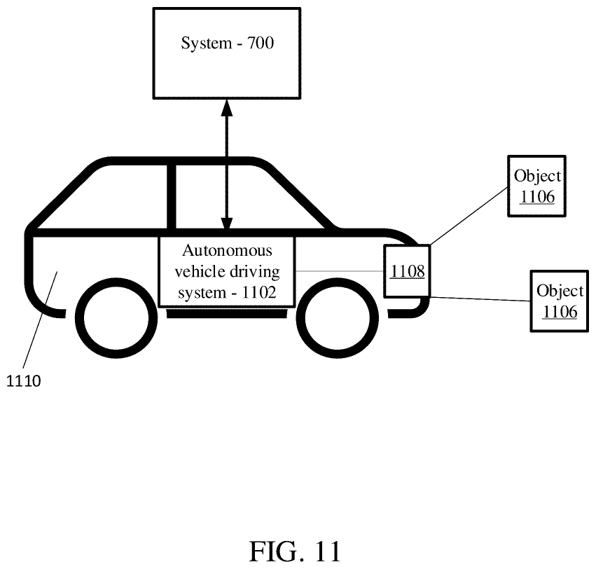

Referring to FIG. 11 with reference to FIG. 7, embodiments of the present invention can be employed in any number of practical applications. A self-training system that discovers and identifies novel objects can be employed in any computer vision scenario. A self-training system that generates synthesized images in a perception model can also be employed in any computer vision scenario. These systems can be employed in autonomous driving applications. In an embodiment, a vehicle 1110 can include an autonomous driving system 1102 (e.g., Advanced Driving Assistance System (ADAS)). The autonomous driving system 1102 includes one or more sensors 1108 that are configured to perceive objects 1106 with which the vehicle 1110 will encounter. The autonomous driving system 1102 can employ computer vision to detect the objects and respond by avoiding them.

The autonomous driving system 1102 can interact with or be a part of system 700, which includes software 706 (FIG. 7). Software 706 can detect novel objects and can update a perception model by providing an identity for novel objects. Software 706 can also determine weakness in the perception model by using as feedback any unknown objects and/or objects that cannot be identified with sufficient accuracy. Software 706 can be distributed or can exist on the vehicle 1110 or remotely from the vehicle 1110 and be accessible over a network, such as, e.g., the Cloud/internet, etc.

Since the system 700 is self-training, the system 700 can be employed concurrently with other functions of the autonomous driving system 1102. For example, while avoiding objects 1106, the system 700 can be learning at the same time to improve performance by synthesizing images for training. In addition, perception models can be improved by using the novel objects to determine any deficiencies in the models' ability to correctly predict objects.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment. However, it is to be appreciated that features of one or more embodiments can be combined given the teachings of the present invention provided herein.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items listed.

The foregoing is to be understood as being in every respect illustrative and exemplary, but not restrictive, and the scope of the invention disclosed herein is not to be determined from the Detailed Description, but rather from the claims as interpreted according to the full breadth permitted by the patent laws. It is to be understood that the embodiments shown and described herein are only illustrative of the present invention and that those skilled in the art may implement various modifications without departing from the scope and spirit of the invention. Those skilled in the art could implement various other feature combinations without departing from the scope and spirit of the invention. Having thus described aspects of the invention, with the details and particularity required by the patent laws, what is claimed and desired protected by Letters Patent is set forth in the appended claims.

What is claimed is:

1. A computer-implemented method for synthesizing an image, comprising:
capturing data from a scene;
decomposing a captured scene into static objects; dynamic objects and sky;
generating bounding boxes for the dynamic objects;
simulating motion of the dynamic objects as static with movement of the bounding boxes;
merging the dynamic objects and the static objects according to density and color of sample points;
blending the sky into a merged version of the dynamic objects and the static objects; and
synthesizing an image from volume rendered rays.

2. The method of claim 1, wherein simulating motion of the dynamic objects includes encoding the dynamic objects using neural radiance field (NeRF).

3. The method of claim 1, further comprising modeling the sky with a sphere radiance model.

4. The method of claim 1, wherein merging the dynamic objects and the static objects includes rendering a scene when an intersection between a bounding box of a dynamic object and a ray view direction occurs.

5. The method of claim 1, wherein blending the sky into the merged version includes alpha blending.

6. The method of claim 5, wherein a rendered color in an image includes c=a*c_{vehicle&background}+(1−a)*c_{sky}, where a is accumulated weight, c_{vehicle&background} is a merged color between a vehicle and background and c_{sky} represents the color of the sky wherein a sky region is segmented out by enforcing (1−a) to be close to 1 at the sky region with a loss.

7. The method of claim 1, further comprising training a self-driving vehicle using synthesized images from the volume rendered rays.

8. The method of claim 7, wherein the training occurs when the self-driving vehicle is operating.

9. A system for synthesizing an image, comprising:
a hardware processor; and
a memory that stores a computer program which, when executed by the hardware processor, causes the hardware processor to:
capture data from a scene;
decompose a captured scene into static objects; dynamic objects and sky;
generate bounding boxes for the dynamic objects;
simulate motion of the dynamic objects as static with movement of the bounding boxes;
merge the dynamic objects and the static objects according to density and color of sample points;
blend the sky into a merged version of the dynamic objects and the static objects; and
synthesize an image from volume rendered rays.

10. The system of claim 9, wherein the computer program further causes the hardware processor to simulate motion of the dynamic objects by encoding the dynamic objects using neural radiance field (NeRF).

11. The system of claim 9, wherein the computer program further causes the hardware processor to model the sky with a sphere radiance model.

12. The system of claim 9, wherein the computer program further causes the hardware processor to merge the dynamic objects and the static objects by rendering a scene when an intersection between a bounding box of a dynamic object and a ray view direction occurs.

13. The system of claim 9, wherein the computer program further causes the hardware processor to blend the sky into the merged version by alpha blending.

14. The system of claim 13, wherein a rendered color of an image includes c=a*c_{vehicle&background}+(1−a)*c_{sky}, where a is accumulated weight, c_{vehicle&background} is a merged color between a vehicle and background and C sky represents the color of the sky wherein a sky region is segmented out by enforcing (1−a) to be close to/at the sky region with a loss.

15. The system of claim 9, wherein the computer program further causes the hardware processor to train a self-driving vehicle using synthesized images from the volume rendered rays.

16. A computer program product for synthesizing an image, the computer program product comprising a computer readable storage medium having program instructions embodied therewith, the program instructions executable by a hardware processor to cause the hardware processor to:
capture data from a scene;
decompose a captured scene into static objects; dynamic objects and sky;
generate bounding boxes for the dynamic objects;
simulate motion of the dynamic objects as static with movement of the bounding boxes;
merge the dynamic objects and the static objects according to density and color of sample points;
blend the sky into a merged version of the dynamic objects and the static objects; and
synthesize an image from volume rendered rays.

17. The computer program product of claim 16, wherein the program instructions further cause the hardware processor to simulate motion of the dynamic objects by encoding the dynamic objects using neural radiance field (NeRF).

18. The computer program product of claim 16, wherein the program instructions further cause the hardware processor to merge the dynamic objects and the static objects by rendering a scene when an intersection between a bounding box of a dynamic object and a ray view direction occurs.

19. The computer program product of claim 16, wherein the program instructions further cause the hardware processor to blend the sky into the merged version by alpha blending, wherein a rendered color of an image includes c=a*c_{vehicle&background}+(1−a)*c_{sky}, where a is accumulated weight, c_{vehicle&background} is a merged color between a vehicle and background and c_{sky} represents the color of the sky wherein a sky region is segmented out by enforcing (1−a) to be close to 1 at the sky region with a loss.

20. The computer program product of claim 16, wherein the program instructions further cause the hardware processor to train a self-driving vehicle using synthesized images from the volume rendered rays.
